(19) United States
(12) Patent Application Publication
(10) Pub. No.: US 2024/0312208 A1
(43) Pub. Date: Sep. 19, 2024

(54) ACTION DETECTION SYSTEM FOR DARK VIDEOS USING SPATIO-TEMPORAL FEATURES AND BIDIRECTIONAL ENCODER REPRESENTATIONS FROM TRANSFORMERS

(71) Applicant: Ashish GHOSH, Kolkata (IN)

(72) Inventors: Ashish GHOSH, Kolkata (IN); Himanshu SINGH, Nagrota (IN); Saurabh SUMAN, Nagrota (IN); Badri N. SUBUDHI, Nagrota (IN); Vinit JAKHETIYA, Nagrota (IN); T. VEERAKUMAR, Nagrota (IN)

(21) Appl. No.: 18/122,269

(22) Filed: Mar. 16, 2023

(51) Int. Cl. G06V 20/40; G06T 5/00; G06V 10/62; G06V 10/70; G06V 10/77; G06V 10/82; G06V 10/94; G06V 40/20

(52) U.S. Cl. CPC G06V 20/41; G06T 5/00; G06V 10/62; G06V 10/70; G06V 10/7715; G06V 10/82; G06V 10/95; G06V 20/46; G06V 40/20; G06T 2207/10016; G06T 2207/20081; G06T 2207/20084; G06T 2207/30196

(57) ABSTRACT

An action detection system for dark or low-light videos is provided to detect human action recognition in dark-light situations. The said system includes a novel deep learning architecture that involves an image enhancement module configured to enhance the low-light image frame of action video sequence followed by an action classification module, to classify the actions from the 3D features extracted from the enhanced image frames.

### TECHNICAL FIELD

The present invention relates to the field of low-illumination image enhancement and action detection in video, and more particularly to action detection system for low illumination/dark videos using spatio-temporal features and bidirectional encoder representations from transformers.

### DESCRIPTION OF THE RELATED ART

The videos/images taken in low-day light or in the night are considered as low illumination, low brightness, low contrast, narrow gray scale range, color distortion etc. videos/images. Due to lack of illumination, the pixel values of these images are mainly concentrated in a low range, therefore, the details of the dark video/image are difficult to distinguish or extract, thereby reducing the recognition of actions performed in the video/image. Further, the existing CNN-based state-of-the-art techniques cannot characterize the spatiotemporal features of the video scene, as they cannot extract meaningful information from the obscured dark videos. Furthermore, most existing Graph Neural Networks (GNNs) typically capture spatial dependencies with the predefined or learnable static graph structure, ignoring the hidden dynamic pattern is very arduous to recognize action in dark/low-light videos. Usually, most of the existing techniques fail due to poor data augmentation techniques, which unexpectedly destroy the data and hence lead to a decrease in classification accuracy. Moreover, developing a high-efficiency algorithm for action recognition is impossible as it needs to enhance the video scene initially and further classify the same. In real-life instances, many videos on which action recognition tasks are to be achieved are untrimmed and of various lengths. The required action takes place in only a small part of the video. Cropping or segmenting the more extensive input videos before sending them to the network may cut out the action. As a result, the best technique is to feed the complete video to the network. However, this is not trivial because of device memory restrictions to various video lengths. Meanwhile, most recurrent neural networks (RNNs) or convolutional neural networks (CNNs) cannot effectively capture temporal correlations, especially for long-term temporal dependencies.

Accordingly there is a need of an action detection system for dark or low-light videos, that utilizes Zero-Reference Deep Curve Estimation (Zero-DCE) followed by the min-max sampling techniques along with spatio-temporal features and bidirectional encoder representations from transformers to enhance the dark videos and bring out the inherent details of the video.

### SUMMARY OF THE INVENTION

According to an aspect of the present invention an action detection system is provided. The action detection system for dark or low-light videos is configured to provide image enhancement module (IEM) and action classification module (ACM). The said system includes one or more processors including an image enhancement module configured to enhance the low-light image frame of action video sequence and an action classification module configured to classify the actions from the 3D features extracted from the enhanced image frames. The image enhancement module includes Zero-Reference Deep Curve Estimation (Zero-DCE) followed by the min-max sampling techniques to enhance the dark videos and demonstrate the inherent details of the video. The Zero-DCE component of IEM adapts to different levels of light conditions. Further, action classification module is configured to combine R(2+1)D followed by graph convolutional network (GCN) succeeded by Bidirectional Encoder Representations from Transformers (BERT). The GCN utilizes features obtained by R(2+1)D to model intrinsic temporal relations for providing a robust encoded representation for action recognition. The use of Graph convolutional networks (GCN) on the top of R(2+1)D as video feature encoder captures the dependencies among the spatial and long term temporal extracted features. The framework of the technique of the present invention is summarized herein as the entire video is taken as input, i.e., V={V1, . . . VL}, V∈R^{h×w}, where h×w specifies the spatial size of each frame and L denotes the video length, i.e., the number of frames in the dark video. Further, employing the image enhancement module to enhance the dark video frames. Using feature extractor, the feature for m-frames snippet of V is then extracted, m=64 is assumed. The output of the spatial R(2+1)D branch is a 512×8×7×7 feature map, which is then average pooled in the spatial domain to reduce it to a dimension of 512×8×1×1. Capturing the spatial and long term temporal dependencies via GCN among the extracted features from the R(2+1)D and receiving the enhanced feature of dimension 256×8. Furthermore, feeding the obtained features into BERT followed by a basic linear layer to get the model's final classification result.

### BRIEF DESCRIPTION OF DRAWINGS

The disclosure will provide details in the following description of preferred embodiments with reference to the following figures wherein:

FIG. 1 shows an exemplary system for action detection where raw frames are extracted from the given low-light videos and Zero-DCE approach is applied to enhance these frames followed by Min-max sampling and passed to feature extractor R(2+1)D, GCN and then to BERT, followed by a basic linear layer to get the model's final classification in accordance with an embodiment of the present invention;

FIG. 2 shows an exemplary graphical representation of Zero-DCE for low-light image enhancement utilized to estimate a plurality of light enhancement curves (LE-curves) that are used to enhance a given input image iteratively where m is the number of iterations in accordance with an embodiment of the present invention;

FIG. 3 shows an exemplary graphical representation of self-attention mechanism in accordance with an embodiment of the present invention;

FIG. 4 shows an exemplary flowchart defining the sequential working steps of the action detection system in accordance with an embodiment of the present invention; and

FIG. 5 shows an exemplary visual representation of Zero-DCE based image enhancement on all classes of ARID dataset in accordance with an embodiment of the present invention; and

FIGS. 6a and 6b show an exemplary confusion matrix representation on the ARID database in accordance with an embodiment of the present invention.

### DETAILED DESCRIPTION OF PREFERRED EMBODIMENTS

Embodiments of the present invention are described below by way of example only. These examples represent the best ways of putting the invention into practice that are currently known to the Applicant although they are not the only ways in which this could be achieved. Forth the functions of the example and the sequence of steps for constructing and operating the example.

The present invention is directed to action detection system for dark videos using spatio-temporal features and bidirectional encoder representations from transformers.

In an embodiment, the present invention solves the fundamental problem of recognition and classification of human action in dark/low-light videos.

In an embodiment, the present invention utilizes spatio-temporal features and Bidirectional Encoder Representations from Transformers for action recognition in dark/low light videos.

In an embodiment, the present invention is applied to action recognition in video. Further, the present invention is not limited to solely action recognition in a video and can be applied to other types of recognition, as readily appreciated by one of ordinary skill in the art given the teachings of the present invention provided herein, while maintaining the spirit of the present invention.

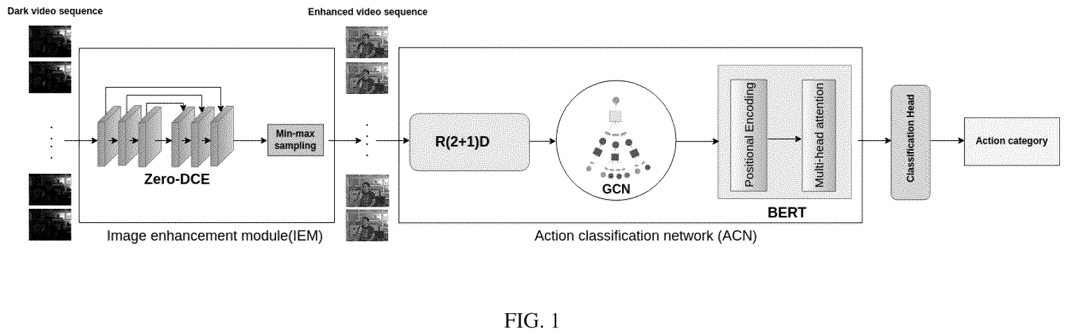

FIG. 1 shows an exemplary system for action detection where raw frames are extracted from the given low-light videos and Zero-DCE approach is applied to enhance these frames followed by Min-max sampling and passed to feature extractor R(2+1)D, GCN and then to BERT, followed by a basic linear layer to get the model's final classification in accordance with an embodiment of the present invention.

The action detection system for low-light videos comprises a video capturing device configured to capture an action video sequence and a server operatively coupled with the video capturing device. The server further comprises a video extractor to receive captured video sequence for generating a plurality of image frame from a sequential action video sequence, a transceiver operatively coupled with video extractor to receive the extracted action video frames and send to one or more processors for processing the video sequence, one or more processors coupled with memory unit and graphics processing unit. The processor further includes an image enhancement module configured to enhance the low-light image frame of action video sequence and an action classification module configured to classify the actions from the 3D features extracted from the enhanced image frames.

The system includes a video capturing device whereas multiple video capturing device such as a wired or wireless camera/video recording system can be used to realize the objective of the present invention. The video captured via the video capturing device may be a low-light action video sequence.

The system also includes a server configured to perform action recognition in dark/low-light videos. The action recognition can involve detecting the presence of objects (e.g., persons), recognizing particular actions performed by the objects and/or particular actions performed by one or more persons using the objects. The server can be located remote from, or proximate to, the video capturing device. The server can include one or more processors, a video extractor, a memory unit, a graphics processing unit and a transceiver. The server may also include other components necessary for functioning of the above mentioned components i.e., stand/holder for placing video capturing device, wires, switches, display unit, LAN/WLAN, Bluetooth, etc. However, for the sake of brevity they are not discussed in detail. The processor and the memory unit of the server can be configured to perform recognition and classification of action performed by the objects in dark/low-light videos received from the video recording system by the remote server. Therefore, a list of recognized actions can be provided for plurality of possible application uses relating to action recognition. Such application uses can involve one or more actions performed responsive to the list, as readily appreciated by one of ordinary skill in the art.

The video extractor is configured to receive the image/video sequence captured via the video capturing device, to generate a plurality of image frame of an action video sequence. In an exemplary embodiment the video extractor employed in the present innovation is a fast forward moving picture experts group (FFMPEG). It is a free and open-source software project that provides a wide range of video and audio processing features. It is intended to be operated through a command line interface and includes several libraries and applications for manipulating and handling video files.

The transceiver is configured to receive the extracted images/action video sequence frames from the video extractor and send the extracted action video frames to one or more processors for processing the video sequence. A transceiver may be used in a wireless or wired communication device for transmitting the information, i.e., extracted action video frames to one or more processors.

The memory unit (such as random access memory (RAM) or read only memory (ROM)) in the present invention is coupled with processor to monitor one or more control signals of the processors. The classification and recognition process performed for extracting the video frames from the low-light video obtained from the action video capturing device are saved in the memory unit. Further the size of the memory unit may depend upon the requirement of the user to realize the objective of the present invention.

The present invention utilizes Graphics Processing Unit (GPU). A graphics processing unit (GPU) is a specialized electronic circuit that controls and alters memory in order to speed up the creation of images in a frame buffer for output to any display device. The processor coupled with memory unit and graphics processing unit performs recognition and classification of human action in dark/low-light videos.

The one or more processors includes an image enhancement module and action classification module operatively coupled to the reference deep central neural network (CNN). The image enhancement module includes an enhancement curve prediction machine learning model i.e., a Zero-DCE a lightweight deep network model configured to estimate plurality of pixel-wise enhancement curves for the sequential frames extracted from the low-light videos. Further, the image enhancement module includes a sampling model. A regular video is made up of three parts: preparing for the action, the beginning of the action, and the end of the action. The length of the video can differ depending on the type of action being performed. This leads to a bias in the frame count, as the model tends to overfit to the point where there is the most significant variation. The Min-max sampling is performed to overcome this drawback. A feature extractor having pre-trained IG65M dataset configured to enhance the sequential frames extracted from the low-light videos. The action classification module includes combination of R(2+1)D and graph convolution neural network (GCN) followed by Bidirectional Encoder Representations from Transformers (BERT).

In an embodiment of the present invention, the image enhancement module (IEM) is utilized to distinguish the notable actions of the object from the dark videos. In an exemplary embodiment an input frame size 3×64×112×112 is utilized to apply Zero-DCE to enhance the frames.

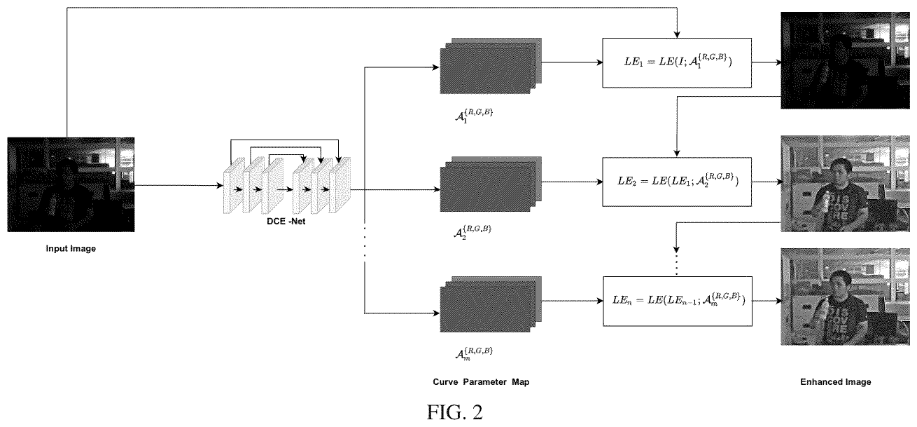

In an embodiment the Zero-Reference Deep Curve Estimation (Zero-DCE) technique is operatively coupled to the min-max sampling strategy to boost the background lighting and identify the actions of the object in the dark videos. FIG. 2 shows an exemplary graphical representation of Zero-DCE for low-light image enhancement utilized to estimate a plurality of light enhancement curves (LE-curves) that are used to enhance a given input image iteratively where m is the number of iterations in accordance with an embodiment of the present invention. Zero-DCE is a low-illumination image enhancement method based on light-enhancement curves estimated from an input image and applied iteratively by mapping all the pixels of the input image. Zero-DCE takes a low-light image as input and returns a set of pixel-wise curve parameter mappings for higher-order curves as output. The Zero-DCE is operatively coupled with Convolutional Neural Network (CNN). The Zero-DCE network includes light-enhancement curve, DCE-Net, and non-reference loss functions.

Accordingly the light-enhancement curve (LE-curve) provides mapping of a low-light image to its enhanced version to provide and/or otherwise involve one or more of the following:
Minimizing information loss due to overflow truncation by placing the improved image's pixel values in a normalized range of [0,1].
The nature of the LE curve is monotonous. It also preserves the differences between neighboring pixels.
In gradient back propagation is a basic curve that can be differentiable.

In an embodiment the convolutional neural network (CNN) comprises seven convolutional layers wherein each layer includes 32 convolutional kernels of size 3×3 and a stride of 1 followed by the ReLU function. It does not include the down sampling and batch normalization layers, which disrupt nearby pixel relationships. For a 256×256 input image with 3 channels, the DCE-Net has just 79, 416 trainable parameters and 5.21G Flops. Zero-DCE is a lightweight model and may be utilized in any device with low processing resources.

The Zero-DCE Model is trained using a weighted, linear combination of the following four non-reference loss functions:
(a) Spatial consistency loss (Lₛₚₐ): The bright (dark) regions in the input image should keep relatively bright (dark) in the enhanced result. Otherwise, the result would have relatively low contrast. By retaining the difference between contiguous regions between the input image and its enhanced version, the spatial consistency loss aids the spatial coherence of the enhanced image. Spatial consistency loss (Lₛₚₐ) is given as follows;

$${L}_{spa} = \frac{1}{K} {\sum }_{i = 1}^{K} {\sum }_{j ϵΩ ( i )}^{K} {( \vert ( {Y}_{i} - {Y}_{J} ) - ( {I}_{i} - {I}_{J} ) \vert )}^{2}$$

where K denotes the number of local regions and Ω(i) denotes the four nearby regions (top, down, left, and right) centered on the location i. Yᵢ and Yⱼ are the average intensities of the ith and jth local regions in the enhanced frame, respectively, while Iᵢ and Iⱼ are the average intensities of the ith and jth local regions in the input frame.
(b) Exposure control loss (Lₑₓₚ): It controls the exposure level to prevent under-/over-exposed areas. This loss measures the distance between the average intensity value of a local region and the well-exposedness level E. Exposure control loss (Lₑₓₚ) s given as follows;

$${L}_{exp} = \frac{1}{M} {\sum }_{k = 1}^{M} ( {Y}_{k} - E )$$

where “M” is the number of non-overlapping 16×16 size local regions and YK is the average intensity value of the “kth” local area in the enhanced frame.
(c) Color constancy loss (L_{col}): The design of color constancy loss, which corrects potential color deviations in the enhanced image. Color constancy loss (L_{col}) can be given as follows;

$${L}_{col} = {\sum }_{∀ ( p , q ) ϵε} {( {J}^{p} - {J}^{q} )}^{2}$$

where ε={(R, G), (R, B), (G, B)} and J^{p} denotes the the average intensity value of the enhanced frames “p” th channel, J^{q} denotes the the average intensity value of the enhanced frames qth channel, and (p, q) are a pair of channels.
(d) Illumination smoothness loss (L_{tvA}): An illumination smoothness loss is applied to each curve parameter map A to preserve the monotonicity relations between neighboring pixels. Illumination smoothness loss (L_{tvA}) is given as follows;

$${L}_{tvA} = \frac{1}{N} {\sum }_{n = 1}^{N} {\sum }_{c ϵξ} {( \vert ( {∇}_{x} {A}_{n}^{c} \vert + \vert ( {∇}_{y} {A}_{n}^{c} ) \vert )}^{2}$$

where ξ={R, G, B}, “N” represents the number of iterations and ∇ₓ denotes the horizontal gradient operator, and ∇_{y} denotes the vertical gradient operator.

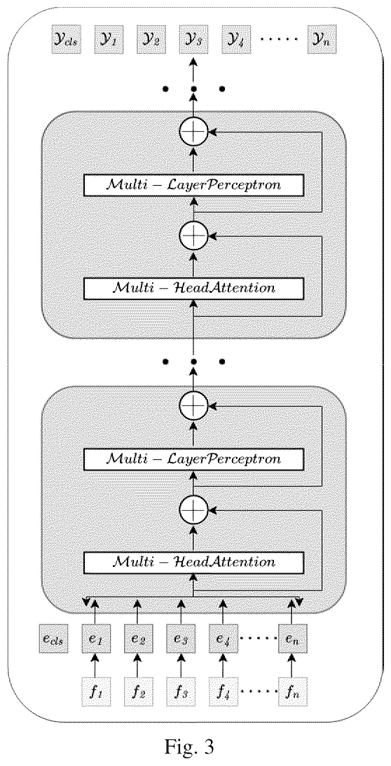

In an embodiment the action classification module is a combination of a spatio-temporal feature extraction module for extracting the 3D features from an image frame representing the action of the user; a video feature encoder configured to capture long-term temporal dependencies of the extracted features; and a masked language model based Bidirectional Encoder Representations from Transformers (BERT) for classifying the actions from the 3D features extracted from the enhanced image frames. The R(2+1)D is ResNet-type architecture consisting of separable 3D convolutions i.e., spatio-temporal feature extraction module in which temporal and spatial convolutions are implemented separately for extracting the clip-level features from a given video. Further, the GCN is a video feature encoder module configured to capture long-term temporal dependencies of the extracted features. Furthermore, the BERT is a masked language model based Bidirectional Encoder Representations from Transformers (BERT) for classifying the actions from the 3D features extracted from the enhanced image frames. FIG. 3 shows an exemplary graphical representation of self-attention mechanism i.e., choosing more useful spatio-temporal features for action recognition in dark videos in accordance with an embodiment of the present invention.

The R(2+1)D is pre-trained on IG65M. IG65M dataset is obtained from Instagram videos. It contains 65 million weakly-supervised public Instagram videos.

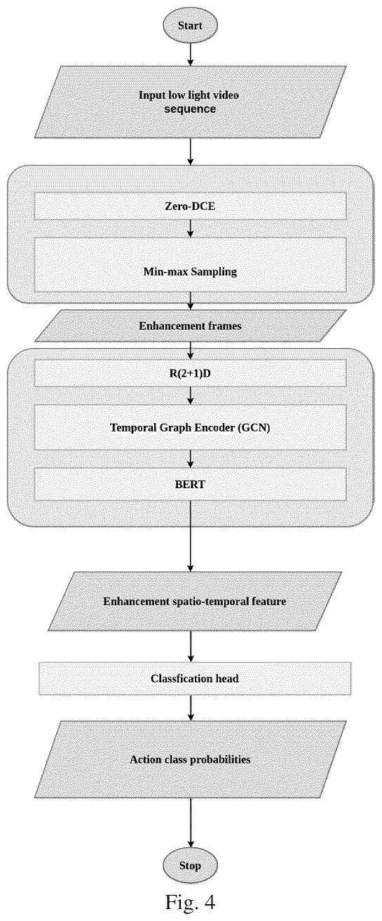

FIG. 4 shows a flowchart defining the sequential working steps of the action detection system in accordance with an embodiment of the present invention as discussed herein:
capturing by a video capturing device an action video sequence compiled from a sequential low-light video frames;
generating by a video extractor a plurality of image frames of the low light action video sequence;
transferring the plurality of the extracted image frames of the action video sequence by a network server to one or more processors; and
processing the extracted image frames of the action video sequence to enhance and classify the low-light image frame of the action video sequence to obtain the final action classification score. The action classification score is the prediction of the probabilities of each action class of the testing video.

In an exemplary embodiment the working of the action detection system is assessed/realized on a Core i7 system with 128 GB RAM and 32 GB GPU using the open-source machine learning framework PyTorch. The Graphics Processing Unit (GPU) necessitates a minimum hardware setup consisting of 4 GB of RAM and a 4 GB GPU, along with the open-source machine learning framework PyTorch. This can be accommodated using a Raspberry Pi or Nvidia-Jetson board, provided that the necessary hardware and software specifications are met. The effectiveness of the system and method is tested on the ARID database. The efficiency of the said scheme is validated quantitatively by Top-1 and Top-5 accuracy. The advantages of the action detection system and its method are evaluated by comparing the results obtained with fifteen existing state-of-the-art action recognition techniques i.e., VGG-TS, TSN, I3D-TS, C3D, Separable-3D, 3D-ShuffleNet, 3D-SqueezeNet, 3D-ResNet-18, I3D-RGB, 3D-ResNet-50, 3D-ResNet-101, Pseudo-3D-199, 3D-ResNext-101, Dark Light-ResNeXt-101 and Dark Light-R(2+1)D-34. The video clips for the ARID dataset were collected using three different commercially available cameras. The footage was only shot at night. All of the clips were gathered from a total of 11 people. They shot the footage in nine outdoor and nine indoor locations, including parking lots, hallways, and sports fields for the outdoor scenes and classrooms and labs for the indoor scenes. The lighting in each scene varies, and almost all videos do not have any direct light shining on the performer. Without editing the raw video footage, it is difficult to articulate the difference between human motion and other objects.

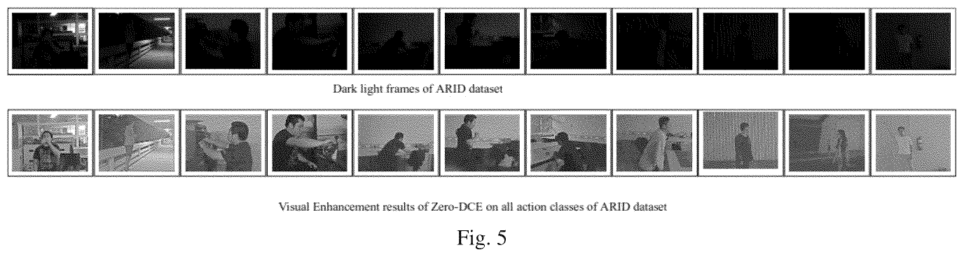

In an embodiment the ARID dataset includes two versions: ARID V1.0 and ARID V1.5. All the videos of the ARID dataset are taken in low light-condition or at night time. ARID V1.0 is configured to include 3,784 video clips, whereas ARID V1.5 is configured to include 6,207 dark videos. The dataset of both the ARID version comprises eleven action classes of lower illumination and dark environment conditions i.e., drinking, jumping, picking, pouring, pushing, running, sitting, standing, turning, walking, and waving. The dark/low light video is taken as input to be classified under the following classes on undergoing the action recognition system in the present invention. The training, testing, and validation split contains 3792, 1768, and 647 videos, respectively, ranging from 33 to 255 frames. FIG. 5 shows an exemplary visual representation of Zero-DCE based image enhancement on all classes of ARID dataset in accordance with an embodiment of the present invention.

In an exemplary embodiment a method for performing action recognition in low-light videos via the action detection module summarized herein comprises the following steps:
capturing by a video capturing device an action video sequence;
generating by a video extractor a plurality of image frames of the low light action video sequence, wherein the input frames size is considered to be 3×64×112×112;
transferring the plurality of the extracted image frames of the action video sequence by a network server to one or more processors;
processing the extracted image frames of the action video sequence by Zero-DCE to enhance the image frame;
extracting feature via utilized R(2+1)D-34 without the average temporal pooling at the end, which was pre-trained on the IG65M dataset;
decomposing the 3D convolution into 2D spatial convolution and 1D temporal convolution via ResNet-type architecture;
receiving output from the feature extractor of the dimension of 512×8×7×7;
applying average pooling layer to provide an output of dimension 512×8;
transposing it to a dimension of the size 8×512 which is the input to the GCN (Temporal Graph Encoder);
using two layer GCN that provides the output of dimension 8×256;
supplying the received input frame to the BERT that provides the feature vector of dimension 9×256 and forwarded to the classification head to classify the action.

In an embodiment Top-1 accuracy and Top-5 accuracy are utilized for evaluating the model performance quantitatively of the system of the present invention. Top-1 accuracy measures the proportion of examples for which the predicted label matches the single target label. In contrast, Top-5 accuracy considers a classification correct if any of the five predictions match the target label. The quantitative evaluation and comparison of the proposed technique on ARID V1.0 with those of the considered fifteen SOTA techniques are provided in Table I. It can be seen that the suggested approach outperforms fifteen other SOTA techniques. A similar analysis of results on ARID V1.5 is shown in Table II.

In an embodiment Table 1 illustrates the Top-1 and Top-5 accuracy results on ARID V1.0 of a few competitive models with the action detection system of the present invention:

| | Top-1 | Top-5 |
|---|---|---|
| Models | Accuracy | Accuracy |
| VOG-TS | 32.08% | 90.76% |
| TSN | 57.96% | 94.17% |
| C3D | 40.34% | 94.17% |
| Separable-3D | 42.16% | 93.44% |
| 3D-ShuffleNet | 44.35% | 93.44% |
| 3D-SqueezeNet | 50.18% | 94.17% |
| 3D-ResNet-18 | 54.68% | 96.60% |
| I3D-RGB | 68.29% | 97.69% |
| 3D-ResNet-50 | 71.08% | 99.39% |
| 3D-ResNet-101 | 71.57% | 99.03% |
| Pseudo-3D-199 | 71.93% | 98.66% |
| I3D Two-stream | 72.78% | 99.39% |
| 3D ResNext-101 | 74.73% | 98.54% |
| DarkLight − ResNext-101 | 87.27% | 99.47% |
| DarkLight − R(2 + 1)D-34 | 94.04% | 99.87% |
| R(2 + 1)D-GCN + BERT(Proposed) | 96.60% | 99.88% |

Table 1 demonstrates the effectiveness of various CNN-based feature extractors. In terms of Top-1 accuracy, the action classification method of the present invention is 9.33% better than DarkLight-ResNeXt-101. In terms of Top-1 accuracy, the action classification network of the present invention surpasses the I3D-Two-stream network, which employs both RGB and flow features as input, by 23.82%. This demonstrates that the action recognition in the dark by the action classification system of the present invention has advantageous results. Meanwhile, when compared to 3D-ResNet-18 and 3D-ResNet-101, it is evaluated that the deeper the network layers, the greater the effect, but the performance of the suggested R(2+1)D-GCN and BERT design with 34 layers is 21.87% better than the 101 layers in 3D-ResNet-101.

In an embodiment Table 2 illustrates the Top-1 and Top-5 accuracy results on ARID V1.5 of a few competitive models and the action detection system of the present invention:

| | Top-1 | Top-5 |
|---|---|---|
| Models | Accuracy | Accuracy |
| 3D-ResNet-18 | 31.16% | 90.49% |
| I3D-RGB | 48.75% | 90.611% |
| I3D Two-stream | 51.24% | 90.95% |
| Darklight + R(2 + 1)D-34 | 84.13% | 97.34% |
| R(2 + 1)D-GCN + BERT(Proposed) | 86.93% | 99.35% |

Table II illustrates the action detection system performance on the benchmark dataset ARID V1.5. The said system achieves 86.93% & 99.35% Top-1 and Top-5 accuracies, respectively. It is observed that the action detection system surpassed the I3D-Two-stream network by 35.69% in Top-1 accuracy. The performance of 3D-ResNet-18 is reduced by 55.77% in terms of Top 1 accuracy.

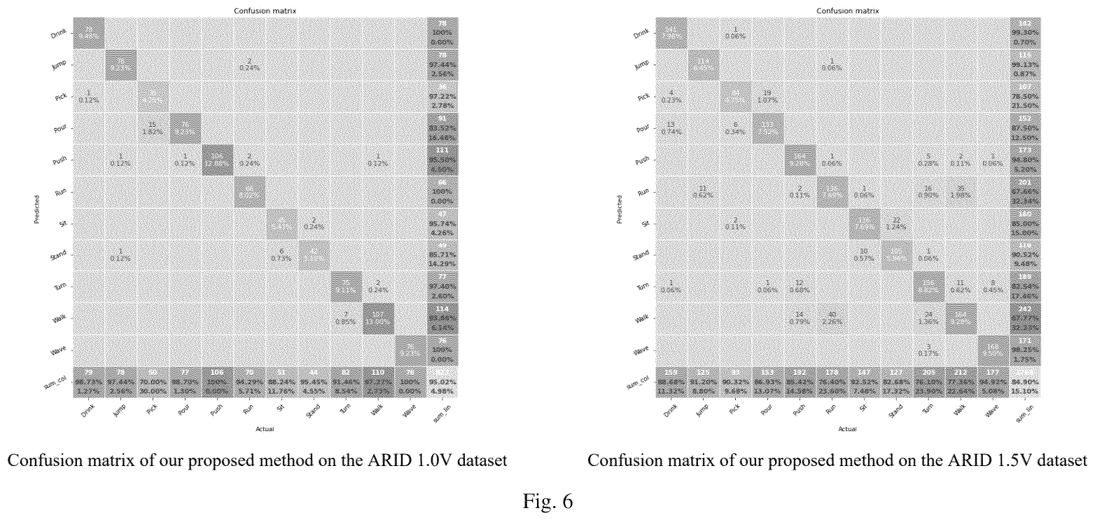

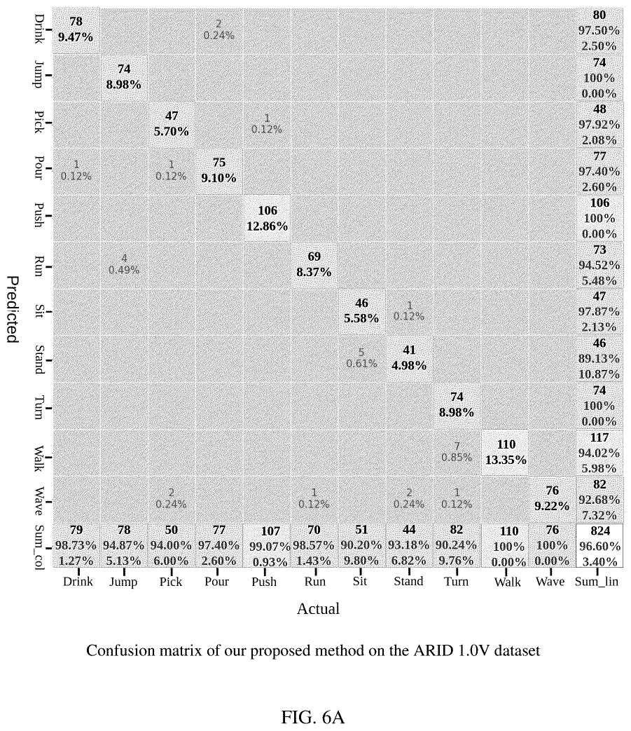

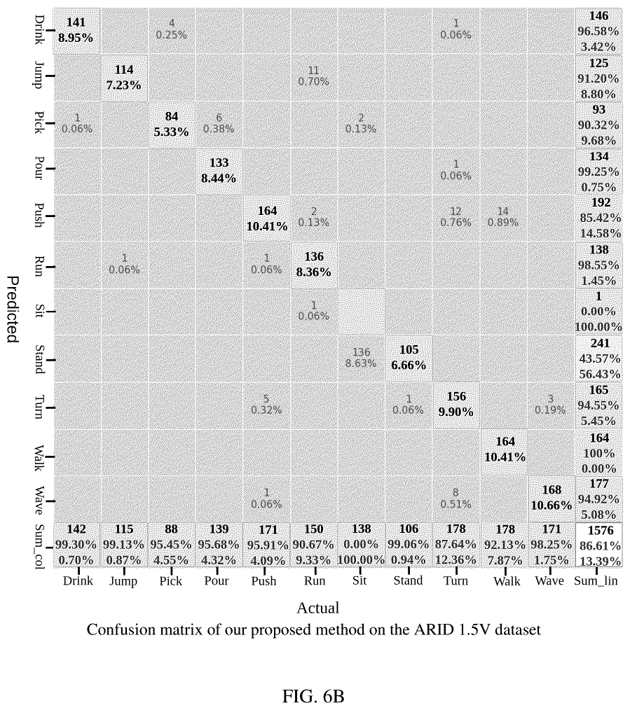

The confusion matrix score obtained by the action recognition method on ARID V1.0 and ARID V1.5 datasets are illustrated in FIGS. 6a and 6b. For ARID V1.5, it is observed that for a few action classes the proposed techniques are getting confused, and hence the confusion matrix indicates the misclassification whereas a better result is obtained with less misclassification in ARID V1.0. It is happening because in ARID V1.5 the number of similar-action videos is more than in ARID V1.0. It may be observed that the present invention provides better results than fifteen SOTA techniques on the ARID V1.0 dataset and comparative results with the Darklight-R(2+1)D-34. The comparisons illustrate that the proposed ACN is far better than many other excellent.

Accordingly, some exemplary suitable environments to which the present invention can be applied can include any environments where action recognition can prove useful such as night surveillance systems, elderly people monitoring, military applications, surveillance system for shopkeepers and so forth. It is to be appreciated that the preceding environments are merely illustrative and, thus, other environments can also be used, while maintaining the spirit of the present invention. Any action type of interest can be recognized, depending upon the implementation. For example, the action may include, but is not limited to, one or more of the following: automated surveillance (for e.g. in public places such as transit hubs, border crossings, subways, transportation hubs, airports, ship ports etc.), elderly behavior monitoring, a sports or other event monitoring, a battle field or a riot scenario monitoring, human-computer interaction and so forth. It is to be appreciated that the preceding actions are merely illustrative.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An action detection system for low-light videos comprising:
a video capturing device configured to capture an action video sequence;
a server operatively coupled with the video capturing device wherein the server comprises:
a video extractor to receive captured video sequence for generating a plurality of image frame from a sequential action video sequence;
a transceiver operatively coupled with video extractor to receive the extracted action video frames and send to one or more processors for processing the video sequence;
one or more processors coupled with memory unit and graphics processing unit wherein the processor comprises
an image enhancement module configured to enhance the low-light image frame of action video sequence; and
an action classification module configured to classify the actions from the 3D features extracted from the enhanced image frames.

2. The action detection system for low-light videos of claim 1 comprising:
an image enhancement module including
an enhancement curve prediction machine learning model configured to estimate plurality of pixel-wise enhancement curves for the sequential frames extracted from the low-light videos; and
a sampling model configured to enhance the sequential frames extracted from the low-light videos.

3. The action detection system for low-light videos of claim 1 comprising:
an action classification module including
a spatio-temporal feature extraction module for extracting the 3D features from an image frame representing the action of the user;
a video feature encoder configured to capture long-term temporal dependencies of the extracted features; and
a masked language model based Bidirectional Encoder Representations from Transformers (BERT) for classifying the actions from the 3D features extracted from the enhanced image frames.

4. The action detection system for low-light videos of claim 1 wherein the action video sequence captured via video capturing device is a low-light action video sequence.

5. The action detection system for low-light videos of claim 1 wherein the memory unit stores classification and recognition process performed for extracting the video frames from the low-light video obtained from the action video capturing device.

6. The action detection system for low-light videos of claim 1 wherein the graphics processing unit controls and alters memory in order to speed up the creation of images in a frame buffer for output.

7. The action detection system for low-light videos of claim 1 wherein enhancement curve prediction machine learning model uses Zero-Reference Deep Curve Estimation to estimate pixel-wise and high-order tonal curves for enhancing image frames.

8. The action detection system for low-light videos of claim 1 wherein a sampling model along with the enhancement curve prediction machine learning model enhances the image frames.

9. A method for performing action recognition in low-light video sequence comprising the steps of:
capturing by a video capturing device an action video sequence;
generating by a video extractor a plurality of image frames of the low light action video sequence;
transferring the plurality of the extracted image frames of the action video sequence by a network server to one or more processors; and
processing the extracted image frames of the action video sequence to enhance and obtain high definition images then classify the same using the action detection system.

10. The method for performing action recognition in low-light videos of claim 6 wherein the processing of the extracted image frames comprises the following steps:
processing the extracted image frames of the action video sequence by Zero-DCE to enhance the image frame;
extracting feature via utilized R(2+1)D-34 without the average temporal pooling at the end, which was pre-trained on the IG65M dataset;
decomposing the 3D convolution into 2D spatial convolution and 1D temporal convolution via ResNet-type architecture;
receiving output from the feature extractor of the dimension of 512×8×7×7;
applying average pooling layer to provide an output of dimension 512×8;
transposing it to a dimension of the size 8×512 which is the input to the GCN (Temporal Graph Encoder);
using two layer GCN that provides the output of dimension 8×256; and
supplying the received input frame to the BERT that provides the feature vector of dimension 9×256 and forwarded to the classification head to classify the action.

11. The method for performing action recognition in low-light videos of claim 6 wherein one or more processors is configured to provide an image enhancement module for enhancing the low-light image frame of action video sequence.

12. The method for performing action recognition in low-light videos of claim 6 wherein one or more processors is further configured to provide an action classification module to classify the actions from the 3D features extracted from the enhanced image frames.

13. The method for performing action recognition in low-light videos of claim 6 wherein the image frame representing the action of the user is extracted using spatio-temporal feature extraction module.

14. The method for performing action recognition in low-light videos of claim 6 wherein the image frame in a video feature encoder is used for capturing long-term temporal dependencies of the extracted features.

15. The method for performing action recognition in low-light videos of claim 6 wherein utilizing the masked language model based Bidirectional Encoder Representations from Transformers (BERT) for classifying the actions from the 3D features extracted from the enhanced image frames.
